(19) United States
(12) Patent Application Publication
(10) Pub. No.: US 2025/0381617 A1
(43) Pub. Date: Dec. 18, 2025

(54) OPTICAL DEVICE FOR SCANNING A LIGHT BEAM OVER A PART TO BE MACHINED

(71) Applicant: CAlLabs, Rennes (FR)

(72) Inventor: Avinash Kumar, Rennes (FR)

(21) Appl. No.: 18/879,165

(22) PCT Filed: May 26, 2023
(86) PCT No.: PCT/EP2023/064250

§ 371 Date: Dec. 26, 2024

(30) Foreign Application Priority Data
Jun. 27, 2022 (FR) FR2206381

(51) Int. Cl. B23K 26/082; B23K 26/06; G02B 26/10

(52) U.S. Cl. CPC B23K 26/082; B23K 26/0643; G02B 26/105

(57) ABSTRACT

An optical device is configured for scanning a light beam on a surface of a workpiece arranged in the device. The light beam transformed by the workpiece is guided toward a fixed position and according to a fixed orientation with respect to the optical device. The device comprises a deflector configured to produce a deflected beam at a chosen angle and also receiving the transformed beam, a first focusing optic optically disposed between the deflector and the workpiece, a second focusing optic optically disposed between the workpiece and the deflector, and at least one reflecting optic for guiding the scanning beam from the first focusing optic to the second focusing optic.

### CROSS-REFERENCE TO RELATED APPLICATIONS

This application is a national phase entry under 35 U.S.C. § 371 of International Patent Application PCT/EP2023/064250, filed May 26, 2023, designating the United States of America and published as International Patent Publication WO 2024/002600 A1 on Jan. 4, 2024, which claims the benefit under Article 8 of the Patent Cooperation Treaty of European Patent Application Serial No. FR2206381, filed Jun. 27, 2022.

### TECHNICAL FIELD

The present disclosure relates to an optical device for scanning a light beam over a surface of a workpiece. Such a device finds its application, in particular, in the field of shaping a light beam, for example, a high-powered laser beam intended for machining, welding, brazing and more generally for any treatment of materials. In such a case of use, the surface of the workpiece presents patterns on which the light beam can selectively be projected in order to modify, in a controlled way, the shape of the reflected or transmitted light beam. The same principles can be used to modify other parameters of the light beam, for example, its spectral content. Other fields can also benefit from embodiments of the disclosure, for example, the field of microscopy or measurement in which the surface to be scanned is that of a sample to be inspected.

### BACKGROUND

US2016368089A1 discloses a head of a laser beam welding equipment. The head may include a diffractive optical element disposed in the beam propagation path, the diffractive optical element being designed to shape the beam. The diffractive optical element is removably positioned in the head of the equipment. Thus, the diffractive optical element can be selected to produce a beam of desired shape and/or size. The document proposes to shape the beam and give it, as needed, a “top hat,” rectangular or ring profile. This approach is restrictive because it requires to intervene on the equipment to replace the diffractive optical element when one wishes to modify the shape of the beam. It is therefore not possible to instantly change the shape of the beam during the soldering step.

The paper “Adjustable-Function Beam Shaping Methods” by Alexander Brodsky, Natan Kaplan, Stefan Liebl, and Rainer Franke in Photonic Views (2019), (doi.org/10.1002/phvs.201900015) proposes to exploit a diffractive optical element with a plurality of patterns. By moving the beam and the optical element relative to each other or by changing the size of the beam, it is possible to choose the relative proportions of the beam projecting into the different patterns. The shape of the beam can thus be continuously controlled.

Numerous arrangements are possible to ensure the displacement of the beam and the diffractive optical element relative to each other. In particular, an arrangement can be envisaged that allows the beam to be swept over the surface of the diffractive optical element in a controlled manner. However, to be usable, these arrangements must meet very specific operating requirements. First, the displacement must be extremely fast and perfectly controllable. The shaped beam must be spatially separated from the original beam, and it must occupy a fixed position and orientation, which is why simply scanning the beam with a steerable mirror on the diffractive optical element is not suitable. For reasons of compactness, optical losses, complexity of alignment, costs and thermal management (especially in applications involving a high-power beam), the number of optical parts, especially movable optical parts such as steerable mirrors or movable lenses is preferably limited.

### BRIEF SUMMARY

An object of the present disclosure is to propose an optical device for scanning a light beam over a surface of a workpiece that meets, at least in part, these requirements.

With a view to achieving this aim, the present disclosure proposes an optical device for scanning a light beam, called the “scanning beam,” over a surface of a workpiece to be scanned disposed in the device, the light beam reflected or transmitted by the workpiece, called the “transformed beam,” being guided toward a fixed position and in accordance with a fixed orientation with respect to the optical device and defining a light beam called the “output beam” of the device, the device comprising:
a deflector having a pivot axis and configured to produce a beam deflected at a chosen angle, the deflected beam remaining contained in a first main plane, the deflector also receiving the transformed beam, the transformed beam remaining contained in a second main plane, different from the first main plane, to produce the output beam;
a first focusing optic having a first optical axis parallel to the first principal plane, the first focusing optic being optically disposed between the deflector and the workpiece, receiving the deflected beam and producing the scanning beam;
a second focusing optic having a second optical axis parallel to the second principal plane, the second focusing optic being optically disposed between the workpiece and the deflector; and
at least one reflecting optic arranged in the device to guide the scanning beam from the first focusing optic to the second focusing optic.

According to other advantageous and non-limiting features of the present disclosure, taken alone or in any technically feasible combination:
the first focusing optic presents a first focal length and the second focusing optic presents a second focal length identical to the first focal length;
the first focusing optic and the second focusing optic are separated from the pivot axis of the deflector by a distance, measured along their optical axes, within +/−10% of their focal length, preferably within +/−5% of their focal length;
the deflector is controlled to limit the angle of deflection to a range of +/−25°;
the optical length between the first focusing optic and the second focusing optic is between half of the average of the first focal length and second focal length and between four times the average of the first focal length and second focal length;
the deflector consists of a device selected from the list formed of: an oscillating mirror, a rotating polygon mirror, a rotating mirror, an electro-optic deflector or as a liquid crystal deflector;
the first main plane and the second main plane are not parallel to each other and the deflected beam and the transformed beam overlap on the deflector;
the first focusing optic and the second focusing optic are formed of off-axis parabolic mirrors;
the at least one reflecting optic is formed of a plane and fixed mirror;
the first main plane and the second main plane are parallel to each other; the first focusing optic and the second focusing optic are constituted by a single focusing optics part; and the reflecting optic piece is formed by a reflecting wedge for guiding the scanning beam contained in the first main plane to propagate in the second main plane;
the single focusing optic is constituted by a cylindrical lens;
the workpiece is configured to modify the shape of the output beam according to the deflection angle of the deflected beam;
the workpiece presents a diffraction pattern;
the diffraction pattern varies continuously or discontinuously;
the workpiece comprises a plurality of phase plates; and
the workpiece comprises a free-form optical piece.

### BRIEF DESCRIPTION OF THE DRAWINGS

Further features and advantages of the present disclosure will be apparent from the following detailed description of embodiments the present disclosure with reference to the appended figures on which:

FIGS. 1A and 1B illustrate the principles of the present disclosure by showing a top view and a side view of a scanning device, respectively;

FIGS. 2A-2C show different embodiments of a deflector of a scanning device according to the present disclosure;

FIG. 3 illustrates free-form optics that can be operated in a scanning device according to the present disclosure;

FIG. 4A depicts a workpiece comprising a plurality of optical parts;

FIG. 4B depicts a workpiece comprising a diffractive optical element presenting a continuous diffraction pattern;

FIG. 4C depicts a workpiece comprising a diffractive optical element presenting a discontinuous diffraction pattern;

FIGS. 5A and 5B depict a first embodiment of an optical scanning device in accordance with the present disclosure;

FIG. 6 shows a variant of the first embodiment;

FIGS. 7A and 7B show, in side view and top view, a second embodiment of a scanning device; and

FIG. 8 shows a workpiece for providing a scanning device 1 that provides tunable and fast spectral filtering of an input beam.

### DETAILED DESCRIPTION

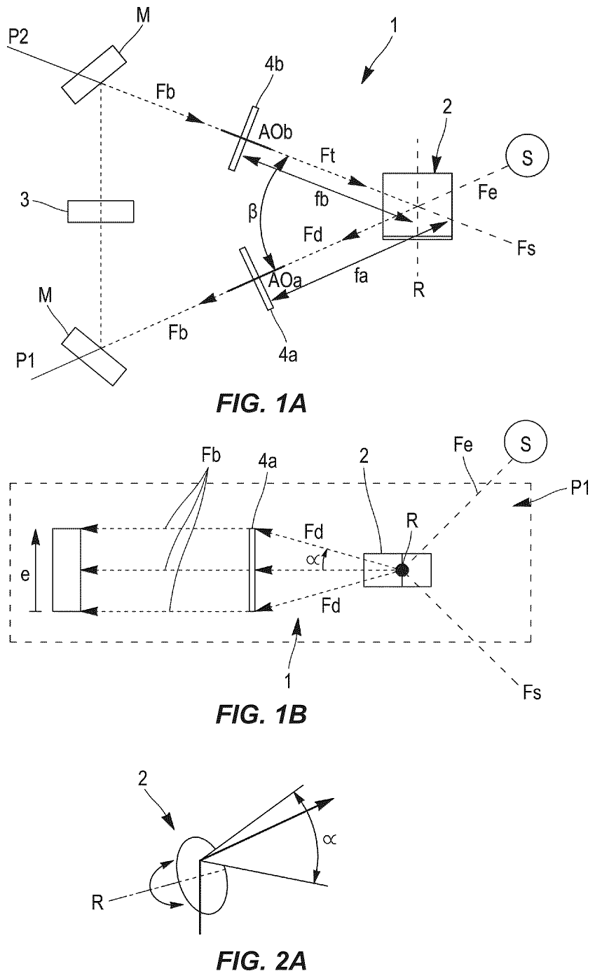

FIGS. 1A and 1B illustrate the principles of an optical device 1 for scanning a light beam in accordance with the present disclosure. This device 1 is formed by a scanning mechanism allowing to quickly and precisely position a light beam, called a “scanning beam,” on a surface of a workpiece 3 arranged within the device. This part 3 can be transparent or reflective to the scanning beam, but in any case, whether this beam is transmitted or reflected, it is transformed by the workpiece 3, for example, in its shape, in its spectral content, its phase, polarization or in any other parameter defining the beam.

As can be seen in FIGS. 1A and 1B, the device 1 comprises a deflector 2 having a pivot axis R and producing a deflected beam Fd according to a chosen angle of deflection α. When the angle of deflection α of the beam Fd is limited, for instance, to a range of +/−15°, the deflected beam Fd remains contained in a first main plane P1. The deflector 2 can be controlled by way of a control system not shown, for example, of an electronic or computer device, this control system being able to provide a command determining this deflection angle α of the deflected beam Fd in the first main plane P1.

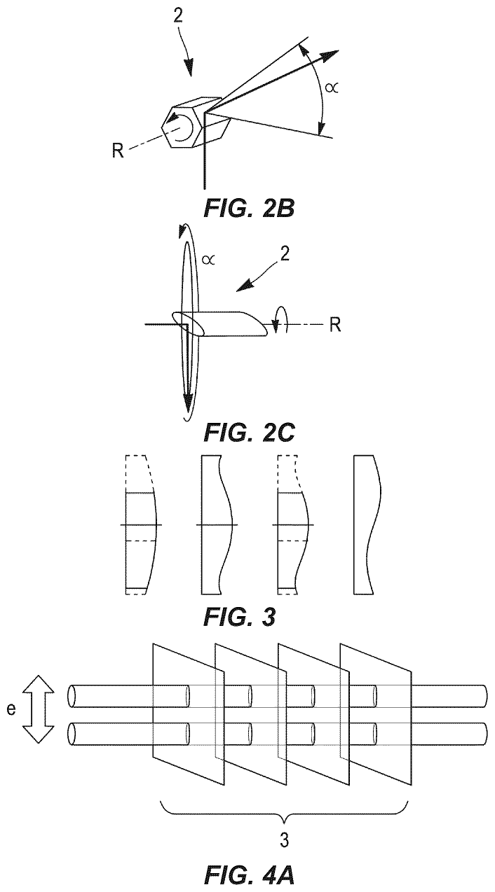

The deflector 2 can be implemented by a wide variety of mechanisms well known to the person skilled in the art. For example, it can be an oscillating mirror (FIG. 2A), a rotating polygon mirror (FIG. 2B), a rotating mirror (FIG. 2C). In these configurations, an input light beam Fe is reflected by a reflecting surface of the deflector 2, this movable reflecting surface being rotatable about its pivot axis R by way of the control system to which the deflector is connected, to produce the deflected beam Fd. In other embodiment, the deflector can be implemented as an electro-optic deflector or as a liquid crystal deflector.

The input light beam Fe can be produced by a light source S, for example, a laser source. The laser source can be of any suitable type such as, for instance, a continuous wave laser, a pulsed laser, a tunable wavelength laser. Preferably, the light source S provides a collimated input light beam Fe. This light source S can be a component of the scanning optical device 1 or an external element. This light source is immobile, i.e., the input beam Fe is produced in a fixed position and orientation with respect to the optical device 1.

When the device 1 is used to modify the shape of a beam, the input beam Fe has a given shape, for example, a Gaussian shape, which is then transformed into another shape in a controlled manner.

More generally, the characteristics of the light source S and of the input beam Fe can be freely chosen according to the intended field of application.

Returning to the description of the schematic diagram of FIGS. 1A and 1B, the deflector 2 also receives a transformed beam Ft, corresponding to the deflected beam Fd after it has propagated in the device 1. In the represented optical device 1, the transformed beam Ft propagates and remains contained in a second main plane P2, different from the first main plane, when the angle of deflection α of the deflected beam Fd is limited, for instance, to a range of +/−15°. The two main plains P1, P2 are disposed, with respect to each other, according to a main plane angle β, typically between 0° and 120°, although other values may be possible. A smaller value of the main plane angle β, for instance, below 45°, also helps confine the deflected beam Fd and transformed beam Ft into, respectively, the first main plane P1 and the second main plane P2.

The deflector 2 thus receives the transformed beam Ft and produces an output beam Fs from the device 1, for example, by reflection of the transformed beam Ft on the movable reflecting surface of the deflector 2 when the latter is implemented according to one of the mechanisms shown in FIGS. 2A-2C.

As will be apparent at the end of this description, the output beam Fs of the device 1 has a fixed position and orientation with respect to the optical device 1, despite the movements of the deflected beam Fd, the scanning beam Fb and the transformed beam Ft. In the context of this description, by “fixed” it is meant that the center of mass of the output beam intensity distribution is maintained during operation within a zone that is of the size of the beam spot. The fact that light beams propagating into the optical device 1 are going twice through the same deflector 2, enables descanning of the beam from the deviation angle imparted by the deflector 2, such as to keep the output beam fixed.

Moreover, the first main plane P1 and the second main plane P2 being distinct, the input beam Fe and the output beam Fs are spatially separated. More precisely, there exists a plane, intersecting the two beams, in which the intensity of the two beams are spatially separated. The output beam Fs can be collected by appropriate optical elements without disturbance of the input beam Fe. It is therefore not necessary to control the polarization of the input beam Fe, nor to modify its polarization during the propagation of the beams in the device 1 to spatially separate the output beam Fs from the input beam Fe. This characteristic is of particular interest when the device 1 is used in a high-power laser system, the polarization of such a source not being generally defined nor stable in time.

Continuing the description of the schematic diagram of FIGS. 1A and 1B, a scanning device 1 in accordance with the present disclosure also comprises a first focusing optic 4a to receive the deflected beam Fd, and to produce the scanning beam Fb, i.e., the beam that will be projected onto the workpiece 3. This first focusing optic 4a is thus optically arranged between the deflector 2 and the workpiece 3 (i.e., in the beam propagation path). In the schematic diagrams of FIGS. 1A and 1B, the optical axis AOa of the first focusing optic 4a is contained in the first main plane P1 of propagation of the deflected beam, but more generally, the optical axis AOa is parallel to this first main plane P1.

The first focusing optic 4a presents a first focal length fa. Advantageously, the first focusing optic 4a is arranged in the device 1 so as to be separated from the pivot axis R of the deflector 2 by a distance, measured along the optical axis AOa, equal to this first focal length fa. In other words, the deflected beam Fd appears to come from the focus of the first focusing optic 4a, so that the scanning beams Fb produced for different deflection angles α are parallel to each other.

Similarly, a scanning device 1 in accordance with the present disclosure includes a second focusing optic 4b for receiving the scanning beam Fb, and producing the transformed beam Ft. This second focusing optic 4b is optically arranged between the workpiece 3 and the deflector 2. In the schematic diagrams of FIGS. 1A and 1B, the optical axis AOb of the second focusing optic 4b is contained in the second main plane P2 of propagation of the deflected beam, but more generally, this optical axis AOb is parallel to this second main plane P2.

The second focusing optic 4b has a second focal length fb identical to the first focal length fa of the first focusing optic 4a. By “identical focal length” it is meant within the context of this disclosure, the two focal lengths may differ at most by 10%. Advantageously, the second focusing optic 4b is arranged in the device 1 so as to be separated from the pivot axis R of the deflector 2 by a distance, measured along the optical axis AOb of the second optical part 4b, equal to this second focal length fb. Consequently, scanning beams Fb projecting parallel to the optical axis AOb on the second optical part 4b will be guided toward the focus of this second optical part, located at the level of the pivot axis of the deflector 2.

In some embodiments, the reflector 2, the first focusing optic 4a and the second focusing optic 4b are arranged so that the foci disposed on the deflector 2 sides of the two focusing optics 4a, 4b are coincident. In other embodiments, the two foci are spatially separated.

The first focusing optic 4a and the second focusing optic 4b can take any suitable form. In particular, they can be optical parts operating in reflection or transmission. Several examples will be given in the various embodiments outlined in a later section of this description.

It is thus contemplated that the scanning beam Fb propagates in the scanning device 1, as a function of the deflection angle «, along optical paths parallel to each other and having an elevation e that varies with the deflection angle α. In other words, the scanning beams Fb produced for two different deflection angles α are parallel to each other.

The workpiece 3 is arranged in the optical device 1 so that its surface intercepts the scanning beam Fb. Consequently, by controlling the deflection angle α of the deflected beam Fd, the elevation e of the scanning beam Fb, and therefore the position on the surface of the workpiece 3 on which this beam will be projected, is controlled.

For simplicity of expression, the beam propagating from the first focusing optic 4a to the second focusing optic 4b is referred to as the “scanning beam,” and the beam propagating from the second focusing optic 4b as referred to as the “transformed beam.” But strictly speaking, the scanning beam Fb modified by the workpiece 3 is transformed with respect to the scanning beam incident on this workpiece 3.

To allow the propagation of the scanning beam Fb between the first focusing optic 4a and the second focusing optic 4b, via the workpiece 3, the scanning device 1 comprises at least one reflecting optic M arranged in the device 1 to guide the scanning beam Fb. In the schematic diagram of FIG. 1A, two reflecting optics M are thus provided. Advantageously, these reflecting optics M are arranged so that the optical length between the first focusing optic 4a and the second focusing optic 4b is equal to the sum of the first focal length fa and the second focal length fb. This ensures that the beams propagating in the device 1, and, in particular, the transformed beam Ft, are properly collimated.

It should be noted that the distances separating the various elements from each other that have been advantageously presented above are not imperative. For example, it is not necessary for the first focusing optic 4a and/or the second focusing optic 4b to be respectively separated from the deflector 2 by precisely their focal distance fa, fb, although it is preferable to keep this separation distance within +/−10% of the focal length, and preferably below +/−5%.

In the embodiment represented on FIG. 1A, the pivot axis of the deflector corresponds to the pivot axis of the deflected beam Fd. In other embodiments, the two pivot axes may be different and separated from each other. This is acceptable to the extent that this separation distance does not exceed the 10% of the focal distance mentioned above. If, however, such a case occurs, it would be then preferable to position the focusing optics with respect to the pivot axis of deflected beam Fd rather than with respect of the deflector 2.

It is also not necessary for the first focusing optic 4a and the second focusing optic 4b to be optically separated by a distance equal to the sum of their focal lengths fa, fb, and this distance can generally be comprised, for pure mechanical constraints of the optical device, between half of the average focal length (fa+fb)/2 and between four times this average focal length. Deviations from the preferred arrangement according to which the first focusing optic 4a and the second focusing optic 4b are optically separated by the sum of their focal lengths fa, fb, lead to the formation of an output beam Fs that is not perfectly collimated, and, in particular, to the formation of an output beam that may be divergent or convergent. This divergence can be corrected by a dedicated optical system, well known to the person skilled in the art, arranged with respect to the deflector 2 to receive the output beam Fs. These deviations do not modify the position and orientation of the output beam Fs, which would make the operation of this beam much more complex.

Finally, the parallelism between the optical axis AOa, AOb and the reference plane P1, P2 should be preferably maintained within +/−20° to limit optical aberrations. Consequently, the term “parallel” in the context of this disclosure should be understood as parallel within this precision of +/−20°.

When the input beam Fe is collimated, the scanning beam Fb tends to converge and pass its focus at the middle of the two focusing optics 4a, 4b, then diverges and gets collimated again after the second focusing optic 4b.

The workpiece 3 can be placed at any position on the optical path between the first focusing optics 4a and the second focusing optics 4b. In particular, it can be placed against, or integrated into, one of the reflecting optics M or one of the focusing optics 4a, 4b.

When the beam presents a significant power, it is preferable to place the workpiece 3 outside a focusing zone of the beam. The focusing zone is distant by a focal length fa along the optical path from the first focusing optic 4a. Indeed, the energy density present in the focusing zone can be important and could in certain cases damage the workpiece 3. This configuration is therefore particularly advantageous as it allows positioning the focusing point in air or vacuum (depending of the actual operational situation of the optical device 1) distant from all optical components of optical device 1, which helps in thermally managing this device.

As already stated, the workpiece 3 can be configured to modify the shape of the output beam Fs according to the chosen angle α of the deflected beam Fd. Alternatively, the workpiece 3 may constitute an inspection body. In any case, the scanning beam Fb is transformed by its interaction, in reflection or transmission, with this workpiece 3.

As stated in the introduction to this disclosure, the ability to change the shape of the output beam Fs is particularly useful in laser machining, drilling, precision cutting and material surface treatment applications. In these applications, the output beam can be, for instance:
a square or rectangular flat top beam;
a circular flat top beam;
a line-shaped flat top beam (product of a flat-top in a first direction and a Gaussian in a direction perpendicular to the first);
a ring-shaped beam; or
a two shape beam, for instance, a combination of a dot and a ring shape or the combination of a dot and “C” shape.

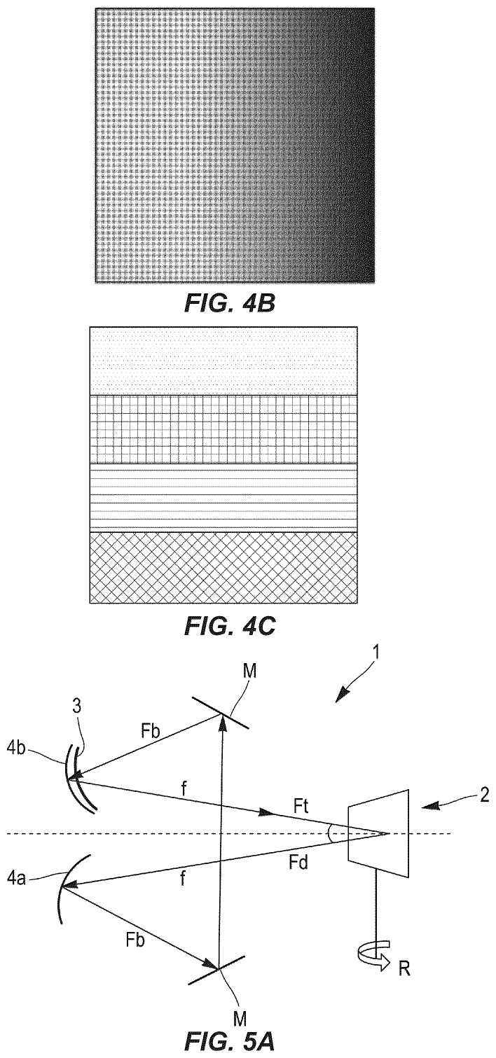

To achieve the shape transformation of the scanning beam Fb, the workpiece 3 may present a diffraction pattern, with the scanning beam intercepting this pattern to change its shape. In other words, the workpiece 3 may comprise a diffractive optical element (“DOE”). The diffraction pattern is variable with the elevation e, and thus a scanning beam Fb having a first elevation (corresponding to a deflected beam having a first angle of deflection) will intercept a different pattern from a scanning beam Fb having a second elevation, different from the first one (and corresponding to a deflected beam having a second angle of deflection different from the first). This diffraction pattern can vary in a continuous way (as presented in FIG. 4B), and in this case a small variation of the deflection angle α leads to a progressive change of shape of the output beam Fs, or discontinuous (as presented in FIG. 4C), and in this case one can alternate very quickly (for a small variation of the deflection angle) between two distinct shapes.

In this application of beam shaping, it can also be envisaged forming the workpiece 3 as a plurality of phase plates, the phase imparted to the scanning beam Fb varying with the elevation e of this beam (i.e., with the deflection angle). Such phase plates can easily be integrated in a plurality of the reflecting optics M or of the focusing optics 4a, 4b, as previously mentioned. The phase plate(s) can be microstructured, i.e., presenting “pixels” whose dimensions are typically between a few microns or less and a few hundred microns. Each pixel has an elevation, with respect to an average plane of the plate, of at most a few microns or at most a few hundred microns. When multiple phase plates are provided, they can be arranged optically in series, as shown in FIG. 4A.

To modify the shape of the scanning beam, the workpiece 3 may also include at least one freeform optics, illustrations of which are shown in FIG. 3. By “freeform optics,” it is meant in the present disclosure an optical element, transmissive or reflective, whose surfaces are not perfectly spherical or flat. For example, it may be:
an off-axis spherical optical element as shown in FIG. 3A;
an aspherical optical element as shown in FIGS. 3B (“on axis”) and 3C (“off axis”), which is rotationally symmetrical about an axis perpendicular to its mean plane; or
an optical element that is not rotationally or translationally symmetric about an axis perpendicular to its mean plane, as shown in FIG. 3D.

In some implementation modes, the workpiece 3 may comprise a plurality of optical parts arranged optically in series and forming an optical assembly combining optical parts of any kind (free form or not, phase plates, diffractive optical elements . . . ).

In the particular case where the optical assembly is composed of free-form optics, a small number of such parts, from 1 to 5, makes it possible to shape a light beam into a large variety of beam forms, in particular, those presented above, according to the elevation e in which the scanning beam Fb is propagated in the optical assembly 3.

### First Embodiment

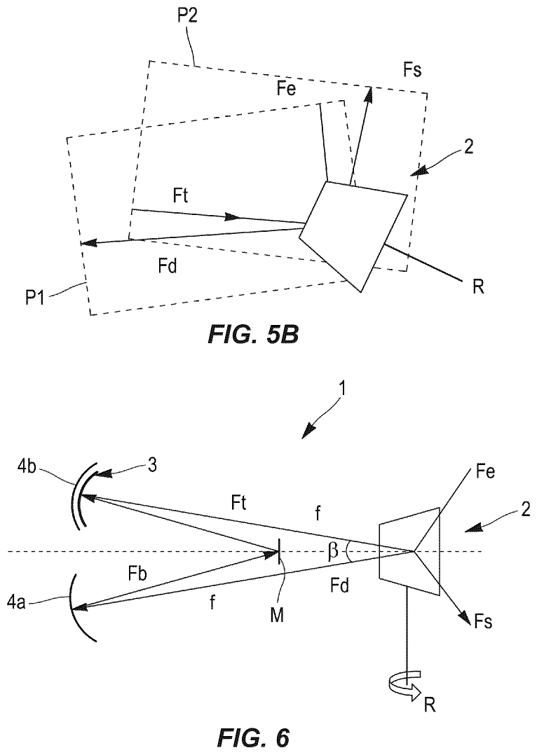

FIGS. 5A (top view) and 5B (side view of the deflector 2) represent a first embodiment of a scanning optical device 1 implementing the principles just discussed. In this first embodiment, the deflector 2 is implemented by an oscillating mirror of the galvanometric type having a single pivot axis R (corresponding to pivot axis of the deflected beam Fd). The input beam Fe and the beam Fd deflected by the deflector mirror propagates in the first main plane P1, which is inclined with respect to the pivot axis R, i.e., this axis R is not perpendicular to the first main plane P1.

The input beam is projected onto the reflecting surface of the mirror at the level of the pivot axis R. The transformed beam Ft also projects onto this reflecting surface in the projection area of the input beam Fe at the pivot axis R. As a result, the deflected beam Fd and the transformed beam Ft overlap on the mirror 2 at the pivot axis R. It should be mentioned that this feature is not mandatory, and that more generally the deflected and transformed beam should preferably cross the pivot axis, but may overlap out of the mirror 2.

The transformed beam Ft and the output beam propagate in the second main plane P2, which is also inclined with respect to the pivot axis R. The two main planes P1, P2 are not parallel to each other and, on the embodiment represented on the figure, intersect at the pivot axis R of the deflector 2, here the oscillating mirror. In this way, it is possible to spatially separate the input beam Fe and the output beam Fs. The output beam Fs of the device 1 has a fixed position and orientation with respect to the optical device 1, regardless of the orientation of the deflector 2.

The first and second focusing optics 4a, 4b are made of off-axis parabolic mirrors. The optical axes of these two optics are respectively arranged in the first main plane P1 and in the second main plane P2. In the configuration shown, the focus of these two focusing optics 4a, 4b is arranged on the pivot axis R of the deflector 2. They have the same focal length.

The scanning beam Fb varies in elevation with the deflection angle α of the deflected beam Fd. The scanning beams Fb produced for two different deflection angles α are parallel to each other. The reflection surface of the second off-axis parabolic mirror is provided with a variable diffraction pattern, allowing the shape of the scanning beam Fb to be changed with its elevation, as discussed in detail in the preceding paragraphs.

The scanning device 1 of this embodiment also includes two reflecting optics M formed by simple plane and fixed mirrors. These mirrors are arranged in the device to guide the scanning beam Fb from the first off-axis parabolic mirror 4a to the second off-axis parabolic mirror 4b. More precisely, these mirrors M are arranged so that the optical distance separating the two focusing optics 4a, 4b corresponds to twice the focal length f of these parts.

It is understood that in this embodiment, the controlled variation of the deflection angle α allows the scanning beam Fb to be projected onto selected zones of the diffraction pattern formed on the second parabolic mirror 4b. In this way, it is possible to produce a transformed beam Ft and an output beam Fs of variable and selected shapes. Also, the output beam Fs of the device 1 has a fixed position and orientation with respect to the optical device 1, regardless of the orientation of the deflector 2.

As previously stated, the distances between the different optical parts of the device 1 need not be precisely as shown. This precise geometrical arrangement has the advantage of preserving the good collimation of the output beam Fs. If it is not respected, it is possible to equip the scanning device 1 with an optical system allowing to correct this.

FIG. 6 represents a variant of the first embodiment in which the precise geometrical arrangement is not respected. The scanning device 1 of this variant comprises only a single reflecting optic M, also formed by a plane and fixed mirror.

The two off-axis parabolic mirrors 4a, 4b are properly arranged to place their respective focus on the pivot axis R of the deflector 2, just as in the case of FIGS. 5A and 5B. The mirror M is arranged in the device 1 to guide the scanning beam Fb from the first off-axis parabolic mirror 4a to the second off-axis parabolic mirror 4b. As this mirror M cannot be placed at the level of the pivot axis R, the optical distance between the two parabolic mirrors 4a, 4b is different to twice their focal length, less than twice their focal lengths in the example shown.

### Second Embodiment

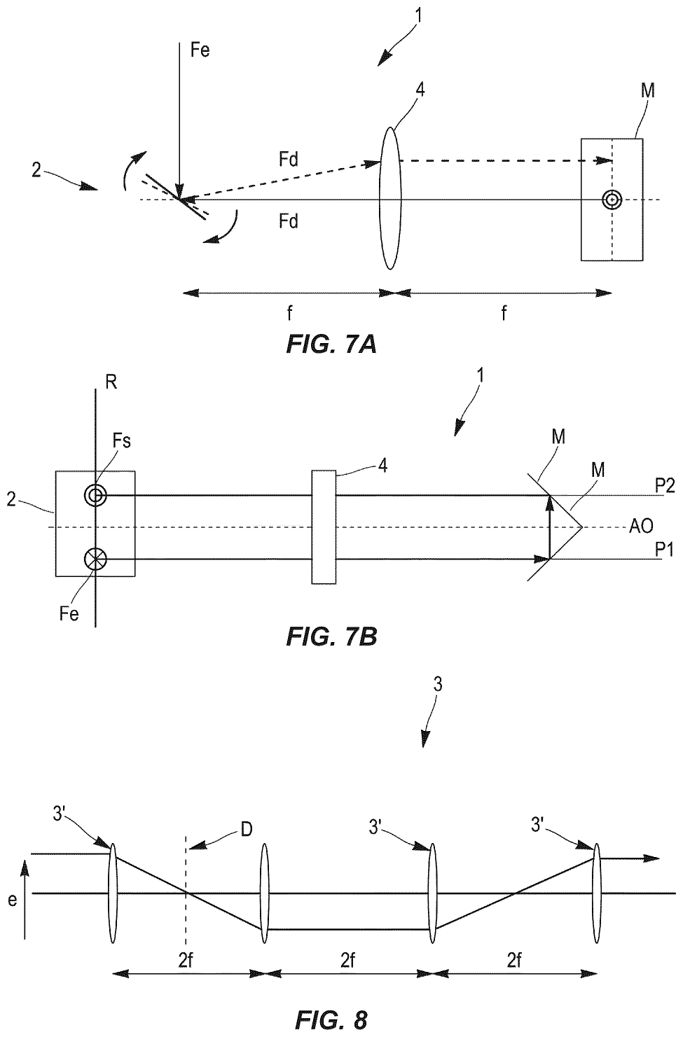

FIGS. 7A and 7B show a side view and a top view of a second embodiment of a scanning device 1. In this embodiment, the first main plane P1 and the second main plane P2 are parallel (and distinct) from each other. These two main planes are also perpendicular to the pivot axis R of the deflector 2, here an oscillating mirror. Consequently, the deflected beam Fd and the transformed beam Ft do not overlap on the deflector 2, although both projects at pivot axis R. The input beam Fe and the output beam Fs are spatially separated from each other. The output beam Fs of the device 1 has a fixed position and orientation with respect to the optical device, regardless of the orientation of the deflector 2.

In the scanning device 1 of this embodiment, a single focusing optic 4 combines the functions of the first focusing optic 4a and the second focusing optic 4b. In this configuration, the optical axis AO of the single focusing optic 4 is between the first main plane P1 and the second main plane P2. This single focusing optic 4 is here constituted by a cylindrical lens, the axis of the cylinder being perpendicular to the first and second main planes P1, P2.

The reflecting optic M is formed by a reflecting wedge to guide the scanning beam Fb contained in the first main plane P1 so that it propagates in return in the second main plane P2. This reflecting wedge is formed by two mirrors, allowing this guidance to be carried out after two reflections.

The preferred geometrical arrangement of this assembly is such that the foci of the single reflecting optic 4 are respectively arranged on the pivot axis R of the deflector 2 and in-between the two reflecting surfaces of the wedge M. The workpiece 3 can be arranged in the vicinity of the reflecting wedge M, for example, on one of its reflecting surfaces or between its two reflecting surfaces.

Also in this embodiment, the controlled variation of the deflection angle α makes it possible to project the scanning beam Fb onto selected areas of the workpiece 3, and in this way it is possible to produce a transformed beam Ft and an output beam Fs of variable and selected shapes, while maintaining the position and orientation of this output beam Fs fixed, with respect to the optical device.

It is worth mentioning that in this embodiment, the two mirrors are close to the focus of the scanning beam Fb, precisely located in between them, so this configuration is preferably used for relatively low power beams. The workpiece 3 can be placed anywhere after the cylindrical lens before it passes the lens again.

### Example of Implementation

FIG. 8 illustrates the use of a scanning device according to the present disclosure outside the realm of beam shaping. More specifically, FIG. 8 shows a workpiece 3 for fast tunable spectral filtering of the input beam.

This workpiece 3 can be placed in a scanning device 1 according to any of the embodiments previously described. This workpiece 3 comprises a system with identical lenses 3′ separated by twice their focal lengths f′. The elevational displacement e of the scanning beam Fb is converted into an angular displacement between the two successive lenses 3′. At a center point of system 3, a diffractive grating D has been placed, which acts as a wavelength filter. The scanning beam Fb at the output of the workpiece 3 (and thus the transformed beam Ft and the output beam Fs of the device 1) will thus present a wavelength chosen according to the deflection angle α defined by the deflector 2.

Of course, the present disclosure is not limited to the embodiments described and variants may be made without leaving the scope of the invention as defined by the claims.

1. An optical device for scanning a light scanning beam on a surface of a workpiece to be scanned, arranged in the device, the light scanning beam being reflected or transmitted by the workpiece to be scanned resulting in a transformed beam being guided toward a fixed position and according to a fixed orientation with respect to the optical device and defining a light output beam of the device, the device comprising:
a deflector having a pivoting axis and configured to produce a deflected beam at a chosen angle, the deflected beam remaining contained in a first main plane, the deflector also receiving the transformed beam, the transformed beam remaining contained in a second main plane, different from the first main plane, to produce the output beam;
a first focusing optic having a first optical axis parallel to the first main plane, the first focusing optic being optically disposed between the deflector and the workpiece, receiving the deflected beam and producing the scanning beam;
a second focusing optic having a second optical axis parallel to the second main plane, the second focusing optic being optically disposed between the workpiece and the deflector; and
at least one reflecting optic arranged in the optical device for guiding the scanning beam from the first focusing optic to the second focusing optic.

2. The optical device of claim 1, wherein the first focusing optic presents a first focal length and the second focusing optic presents a second focal length identical to the first focal length.

3. The optical device of claim 2, wherein each of the first focusing optic and the second focusing optic is separated from the pivot axis of the deflector by a distance, measured along the respective optical axis thereof, within +/−10% of the respective focal length thereof.

4. The optical device of claim 1, wherein the deflector is controlled to limit the angle of deflection to a range of +/−25°.

5. The optical device of claim 1, wherein the optical length between the first focusing optic and the second focusing optic is between half of the average of the first focal length and second focal length and between four times the average of the first focal length and second focal length.

6. The optical device of claim 1, wherein the deflector comprises a device selected from among: an oscillating mirror, a rotating polygon mirror, a rotating mirror, an electro-optic deflector or a liquid crystal deflector.

7. The optical device of claim 1, wherein the first main plane and the second main plane are not parallel to each other and the deflected beam and the transformed beam overlap on the deflector.

8. The optical device of claim 1, wherein the first focusing optic and the second focusing optic comprise off-axis parabolic mirrors.

9. The optical device of claim 1, wherein the at least one reflecting optic comprises a fixed planar mirror.

10. The optical device of claim 1, wherein:
the first main plane and the second main plane are parallel to each other;
the first focusing optic and the second focusing optic are constituted by a single focusing optic; and
the at least one reflecting optic comprises a reflecting wedge for guiding the scanning beam contained in the first main plane to propagate in the second main plane.

11. The optical device of claim 1, wherein the single focusing optic comprises a cylindrical lens.

12. The optical device of claim 1, wherein the workpiece is configured to modify the shape of the output beam according to the deflection angle of the deflected beam.

13. The optical device of claim 12, wherein the workpiece presents a diffraction pattern.

14. The optical device of claim 13, wherein the diffraction pattern varies continuously or discontinuously.

15. The optical device of claim 12, wherein the workpiece comprises a plurality of phase plates.

16. The optical device of claim 12, wherein the workpiece comprises a free-form optical piece.

17. The optical device of claim 3, wherein the distance is within +/−5% of the respective focal length.
